(19) United States
(12) Patent Application Publication
(10) Pub. No.: US 2026/0117711 A1
(43) Pub. Date: Apr. 30, 2026

(54) METHOD FOR REACTIVATING A COMBUSTION ENGINE IN STANDBY MODE DURING AN ASYMMETRIC OPERATING MODE IN A MULTI-ENGINE AIRCRAFT

(71) Applicant: AIRBUS HELICOPTERS, Marignane Cedex (FR)

(72) Inventor: Stéphane CERQUEIRA, Eguilles (FR)

(73) Assignee: AIRBUS HELICOPTERS, Marignane Cedex (FR)

(21) Appl. No.: 19/270,867

(22) Filed: Jul. 16, 2025

(30) Foreign Application Priority Data
Oct. 29, 2024 (FR) FR2411828

(51) Int. Cl. F02C 9/28; B64D 27/10; B64D 31/06; B64F 5/60; F02C 9/42

(52) U.S. Cl. CPC F02C 9/28; B64D 27/10; B64D 31/06; B64F 5/60; F02C 9/42

(57) ABSTRACT

A method of piloting a multi-engine aircraft having an asymmetric operating mode wherein at least one engine is an active engine regulated by a regulation system by outputting a non-zero active driving power participating in the rotation of a rotor and at least one engine is a passive engine in standby mode. During an asymmetric operating mode, the method comprises the steps of detecting, using the regulation system, an operation of the power plant in an at-risk k flight phase preceding a flight phase unfavorable to an exit from the asymmetric operating mode; and following the detection of an operation of the power plant in the at-risk flight phase, reactivation of the passive engine.

### CROSS REFERENCE TO RELATED APPLICATION

This application claims priority to French Patent Application No. FR 24 11828 filed on Oct. 29, 2024, the disclosure of which is incorporated in its entirety by reference herein.

### TECHNICAL FIELD

The present disclosure relates to a method for reactivating a combustion engine in standby mode during asymmetric operation in a multi-engine aircraft.

### BACKGROUND

An aircraft may comprise a plurality of combustion engines for setting in motion a mechanical system, and for example a mechanical system rotating at least one rotary wing on a helicopter.

The combustion engines may take the form of a turboshaft engine, possibly with a free turbine. A free-turbine turboshaft engine comprises a gas generator provided with a compressor, a combustion chamber and a high-pressure expansion assembly constrained to rotate with the compressor. The compressor may be provided with one or more compression stages. Likewise, the expansion assembly may comprise one or more expansion turbines. In addition, the free-turbine turboshaft engine comprises at least one low-pressure working turbine, i.e., one that is mechanically independent in rotation from the compressor and the high-pressure expansion assembly. The working turbine then rotates a power shaft connected to the mechanical system to be set in motion.

According to another example, a combustion engine may comprise a piston engine.

Thus, a rotary-wing aircraft may comprise a power plant having a plurality of combustion engines for setting in motion a mechanical system, and in particular a power transmission system rotating at least one rotary wing.

Optionally, the power plant may operate in a cooperative operating mode wherein the combustion engines each generate driving power that jointly contributes to setting the mechanical system in motion.

The power plant may also operate in an asymmetric operating mode by putting one of the engines in standby mode during certain operating phases of the aircraft. On a rotary-wing aircraft, during the asymmetric mode, at least one active engine is regulated to ensure the rotating of the rotary wing by transmitting a non-zero active driving power to the rotary wing via its power shaft. However, at least one passive engine may be in standby mode.

An engine in standby mode can be shut down by having a shut-down combustion chamber. The combustion chamber of the passive engine is then no longer supplied with fuel, and on a turboshaft engine the rotating parts of the gas generator may or may not be set in motion by an electric machine. Alternatively, an engine in standby mode can operate in idle or super-idle mode, having a combustion chamber ignited and supplied with fuel, the engine in standby mode operating at very low speed and transmitting no power to the rotary wing, with the active engine or engines providing the entire power supply. For example, the passive engine is in idle mode with a rotation speed of around 40% of its rated speed.

Document EP 3209563 describes, in particular, an asymmetric operating mode.

To exit the asymmetric operating mode, the passive engine must be reactivated, by being controlled to increase the power output. However, reactivation can be difficult under certain conditions.

Document FR 3135965 proposes heating a combustion engine in standby mode with hot air from an active combustion engine, when the combustion engine in standby mode is subject to icing conditions.

### SUMMARY

The object of the present disclosure is therefore to propose a method and an aircraft for optimizing the reactivation of a combustion engine in standby mode during an asymmetric operating mode by following a strategy other than that described in FR 3135965.

The disclosure thus relates to a method for piloting an aircraft, said aircraft having a power plant comprising at least two combustion engines and a transmission system connected to at least one rotor, each combustion engine having a power shaft connected to the transmission system, the method comprising an asymmetric operating mode comprising regulation, at an active speed using a regulation system, of at least one active engine of the at least two combustion engines, the active engine outputting, at the active speed and via its power shaft, a non-zero active driving power that contributes to the rotation of the rotor, the asymmetric operating mode comprising, together with the regulation of the active engine at the active speed, putting in standby mode at least one passive engine of the at least two combustion engines, the passive engine transmitting no power to the rotor.

Consequently, in the asymmetrical operating mode, the method comprises the following steps:
detecting, using the regulation system, an operation of the power plant in an at-risk flight phase preceding a flight phase unfavorable to an exit from the asymmetric operating mode, and therefore to reactivation of the passive engine to return to a collaborative operating mode; and
following said detection of an operation of the power plant in the at-risk flight phase, reactivation, using the regulation system, of the passive engine, that then becomes an active engine regulated at an active speed.

The regulation system may comprise part of the avionics system of the aircraft.

Thus, the method goes against the prejudices resulting from document FR 3135965, that suggests warming up an engine in standby mode. Documents US2020256265A1, FR3135965A1 and WO2024161091A1 are also known.

In the asymmetric operating mode, at least one combustion engine is deliberately put in standby mode, with the active engine or engines providing the entire power supply. The passive engine may have a shut-down combustion chamber and, on a turboshaft engine, the rotating parts of the gas generator can be set in motion by an electric machine. Alternatively, the passive engine may have an ignited combustion chamber without transmitting driving power to the rotor. In this case, the passive engine has a low rotational speed compared with its rated speed, for example of order 40% of the rated speed.

The passive engine is ventilated, with outside air continuing to flow in this engine, in particular when the aircraft comprises a dynamic air intake.

The disclosure therefore proposes monitoring the current flight conditions to determine whether the aircraft is operating in an at-risk flight phase likely to lead the aircraft to operate in the short term in flight conditions unfavorable to an exit from the asymmetric operating mode. If so, the passive engine is reactivated before the unfavorable flight conditions are reached. If necessary, the combustion chamber is reignited. If the passive engine is in idle mode, this engine is reactivated by being accelerated before the flight conditions unfavorable to reactivation are reached. The present disclosure thus makes it possible to secure the asymmetric operating mode.

The method may also comprise one or more of the following features, taken individually or in combination.

According to a first variant, following the detection of an operation of the power plant in the at-risk flight phase, the method may comprise emitting an alarm using an alerter, said regulation system carrying out said reactivation of the passive engine following a maneuver of a human-machine control interface.

In this case, the method alerts a pilot that the current flight conditions mean that the asymmetric mode must be exited. The pilot can then maneuver the human-machine control interface for this purpose. This interface can also be used to activate the asymmetric mode.

According to a second variant, said reactivation of the passive engine can be performed automatically by the regulation system following said detection of an operation of the power plant in the at-risk flight phase.

In this case, the regulation system automatically reactivates the passive engine. An alarm can be emitted in parallel using the alerter, to warn the pilot of the exit from asymmetric operating mode.

Optionally, the aircraft can comprise a parameter-setting interface so that a pilot can select the application of the first variant or the second variant.

According to one possibility compatible with the preceding possibilities, the method may comprise measuring at least one monitoring parameter using a respective sensor of the regulation system, and said detection of an operation of the power plant in the at-risk flight phase may comprise detecting that said monitoring parameter has a current value less than an associated limit.

At least one aircraft monitoring parameter is measured and compared with its own limit, to determine whether the asymmetric operating mode should be exited. For each monitoring parameter, the value of the associated limit can be established by tests, calculations and/or simulations.

For example, said at least one monitoring parameter may comprise at least one of the following parameters:
a temperature value that is a function of an outside temperature of the air surrounding the aircraft measured using an outside temperature sensor, and said associated limit is a stored outside temperature limit, detecting an operation of the power plant in the at-risk flight phase comprising detecting that the temperature value is less than the stored outside temperature limit;
an oil temperature of an oil of a lubrication circuit of the passive engine measured using an oil temperature sensor, and said associated limit is a stored oil temperature limit, detecting an operation of the power plant in the at-risk flight phase comprising detecting that said oil temperature has a current value less than the stored oil temperature limit; and
a fuel temperature for a fuel supplying the passive engine measured using a fuel temperature sensor, and said associated limit is a stored fuel temperature limit, detecting an operation of the power plant in the at-risk flight phase comprising detecting that said fuel temperature has a current value less than a stored, fuel temperature limit.

Optionally, all three cited parameters are monitored simultaneously.

Indeed, the outside air circulates in the passive engine. This outside air temperature therefore has an impact on the temperature of the passive engine components.

Environmental conditions also have an impact on engine oil and fuel temperatures. Reactivating the passive engine can be difficult when oil and/or fuel temperatures are particularly low.

Optionally, the above-mentioned temperature value may be equal to the outside temperature measured using the outside temperature sensor.

Alternatively, the above-mentioned temperature value can be calculated by the regulation system as a function of the outside temperature and a current speed of the aircraft measured using a speed sensor.

For example, such a current speed could be the air speed of the aircraft. The higher the current speed of the aircraft, the more the passive engine is fed with fresh outside air. The regulation system can therefore include a mathematical law supplying the temperature value as a function not only of the outside temperature, but also of this current speed in order to take account of this feeding of air likely to cool the passive engine.

In a complementary or alternative manner, said at least one monitoring parameter may comprise an ambient temperature in an engine compartment housing the passive engine measured using an ambient temperature sensor, and said associated limit is a stored ambient temperature limit, detecting an operation of the power plant in the at-risk flight phase comprising detecting that said ambient temperature has a current value less than the stored ambient temperature limit.

Indeed, the temperature prevailing in the engine compartment of the passive engine can have an impact on the operation of this engine.

In a complementary or alternative manner, said at least one monitoring parameter may comprise an internal temperature in the passive engine measured using an internal temperature sensor, and said associated limit is a stored internal temperature limit, detecting an operation of the power plant in the at-risk flight phase comprising detecting that said internal temperature has a current value less than the stored internal temperature limit.

For example, the temperature in the combustion chamber may be measured, and reactivation may be difficult below an associated limit.

In a complementary or alternative manner, or even in particular if the passive engine is in an idling mode, said at least one monitoring parameter may comprise an oil pressure of an oil of a lubrication circuit of the passive engine, said oil pressure being measured using an oil pressure sensor and said associated limit being a stored oil pressure limit, detecting an operation of the power plant in the at-risk flight phase comprising detecting that said oil pressure has a current value less than the stored oil pressure limit.

In a complementary or alternative manner, or even in particular if the passive engine is in an idling mode, said at least one monitoring parameter may comprise a fuel pressure of a fuel supplying the passive engine and said associated limit is a stored fuel pressure limit, said fuel pressure being measured using a fuel pressure sensor, detecting an operation of the power plant in the at-risk flight phase comprising detecting that said fuel pressure has a current value less than the stored fuel pressure limit.

According to one possibility compatible with the preceding possibilities, the piloting method according to the disclosure can comprise an emission using the alerter of an alert signaling an operation of the aircraft in a transient phase when said at least one monitoring parameter is greater than or equal to said associated limit and less than or equal to an associated threshold, the associated threshold being greater than said associated limit.

A second limit can be implemented for each monitoring parameter. This second limit is referred to as the “threshold” to distinguish it from the limit that necessarily implies exit from the asymmetric operating mode. An alert is emitted when a monitoring parameter has a value between the associated threshold and limit. This alert can be used to signal to a pilot that the aircraft is approaching flight conditions requiring exit from asymmetric operating mode. A pilot can then choose to exit these flight conditions, for example by slowing down and/or reducing the altitude of the aircraft, to exit the asymmetric operating mode, or simply to pay closer attention to the changing flight conditions.

The disclosure also relates to an aircraft, said aircraft having a power plant comprising at least two combustion engines and a transmission system connected to at least one rotor, each combustion engine having a power shaft connected to the transmission system, said aircraft comprising an asymmetric operating mode comprising regulation, at an active speed using a regulation system, of at least one active engine of the at least two combustion engines, the active engine outputting, at the active speed and via its power shaft, a non-zero active driving power that contributes to the rotation of the rotor, the asymmetric operating mode comprising, together with the regulation of the active engine at the active speed, putting in standby mode at least one passive engine of the at least two combustion engines, the passive engine transmitting no power to the rotor.

The regulation system is then configured to implement the method of the disclosure.

To this end, the regulation system may comprise at least one controller configured to: i) detect operation of the power plant in an at-risk flight phase, for example by comparing the current value of one or more monitoring parameters with one or more respective limits, and ii) following said detection of an operation of the power plant in the at-risk flight phase, reactivate the passive engine, and thus exit the asymmetric mode.

For this purpose, the regulation system may comprise at least one of the following sensors: an outside temperature sensor measuring an outside temperature of the air surrounding the aircraft, one oil temperature sensor per combustion engine measuring an oil temperature of an oil circulating in the combustion engine, a fuel temperature sensor, possibly common or one per engine, measuring a fuel temperature of a fuel supplying each combustion engine, a speed sensor measuring a current speed of the aircraft, one ambient temperature sensor per combustion engine measuring an ambient temperature in a compartment housing a combustion engine, one internal temperature sensor per combustion engine measuring an internal temperature in the combustion engine, one oil pressure sensor per combustion engine, one fuel pressure sensor per combustion engine measuring a fuel pressure of the fuel circulating in the combustion engine.

The regulation system may also include an alerter.

### BRIEF DESCRIPTION OF THE DRAWINGS

The disclosure and its advantages appear in greater detail from the following description of examples given by way of illustration with reference to the accompanying figures, wherein:

FIG. 1 is a view of an aircraft according to the disclosure; and

FIG. 2 is a diagram illustrating the applied method.

### DETAILED DESCRIPTION

Elements present in more than one of the figures are given the same reference signs in each of them.

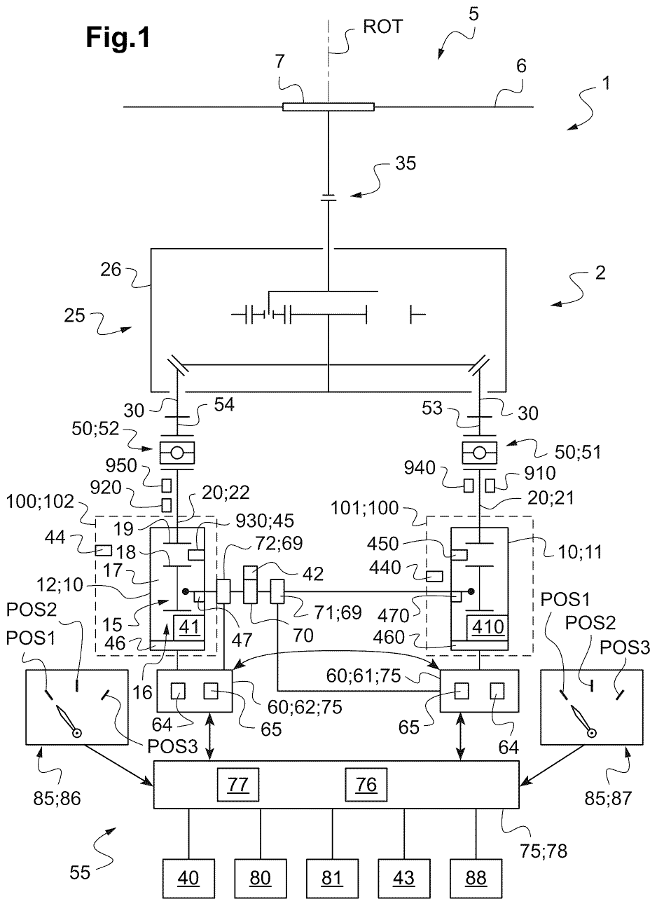

FIG. 1 shows an example of an aircraft 1 according to the disclosure. This aircraft 1 comprises a rotor 5. This rotor 5 is equipped with a plurality of blades 6 that can rotate and may be supported by a hub 7 or equivalent. For example, the rotor 5 forms a fixed or tilting propeller, a rotary wing or an anti-torque rotor.

The aircraft 1 has a power plant 2 for rotating the rotor 5. This power plant 2 is provided with at least two combustion engines 10. Reference sign 10 designates any combustion engine, and reference signs 11 to 12 designate specific engines if necessary. Each combustion engine 10 is housed in an engine compartment 100. Reference sign 100 designates any engine compartment, with reference signs 101 and 102 designating the engine compartments of combustion engines 11, 12 respectively.

According to one example, at least one combustion engine 10 may be a turboshaft engine. Such a turboshaft engine 10 comprises a gas generator 15 that is equipped with at least one compression turbine 16, a combustion chamber 17 into which the fuel is injected and at least one expansion turbine 18 constrained to rotate with the one or more compression turbines 16. Moreover, the turboshaft engine may comprise at least one working turbine 19 that directly or indirectly sets a power shaft 20 of the engine 10 in motion.

Alternatively, at least one combustion engine 10 may be a piston engine equipped with combustion chambers and a power shaft.

Irrespective of the type of engines, each combustion engine 10 therefore comprises a power shaft 20 connected to a power transmission system 25. The power transmission system 25 is then connected to the rotor 5 in the usual way. Reference 20 denotes any power shaft, references 21, 22 denoting particular power shafts of the two engines 11, 12 respectively.

By way of illustration, the power transmission system 25 may be provided with a power transmission gearbox 26 that is mechanically interposed between the engines 10 and the rotor 5. The power transmission gearbox 26 may be provided with one input shaft 30 for each engine 10 and various gears arranged between the input shafts 30 and the rotor mast 35 secured to the hub 7.

The power transmission system 25 may comprise at least one freewheel 50, 51, 52, for example between each engine 10 and the power transmission gearbox 26, and/or at least one connecting shaft 53, 54, and/or at least one connector allowing misalignments. The literature describes various types of power transmission gearboxes and various mechanical trains, the example described being given solely by way of illustration.

Furthermore, the engines 10 are combustion engines that run on fuel and can be started by starters that are not illustrated for the sake of clarity. The aircraft 1 therefore comprises a regulation system 55 for piloting the starters and the power output by each engine 10 via its power shaft 20.

Thus, the regulation system 55 comprises one fuel metering device 69 per engine 10. Each engine 10 is then connected via its own fuel metering device 69 to at least one fuel tank 70. Reference sign 69 denotes any fuel metering device and reference signs 71, 72 denote particular fuel metering devices of the two engines 11, 12 respectively.

The regulation system 55 may comprise one engine computer 60 per engine 10. Each engine computer 60 may comprise a processing unit. Such a processing unit may have, for example, at least one processor 64 and at least one memory 65, at least one integrated circuit, at least one programmable system, or at least one logic circuit, these examples not limiting the scope to be given to the term “processing unit”. The engine computers 60 can communicate with each other via wired or wireless links.

According to the described example, the power plant 2 comprises two engine computers 61, 62 controlling two engines 11, 12 respectively. Each engine computer 60 is configured to pilot the associated engine 10 and operate it at the required speed. In particular, each engine computer 61, 62 can control the fuel metering device 71, 72 of this engine 11, 12. Each engine computer 61, 62 can be connected to multiple sensors in order to control the associated engine 11, 12, such as, for example, a temperature sensor 930 measuring the gas temperature for example at the inlet of a free turbine, a speed sensor measuring for example the speed of rotation of a gas generator of the turboshaft engine, a torque meter 910, 920 measuring an engine torque on a rotating member, a speed sensor 940, 950 measuring, for example, the speed of rotation of this rotating member, a torque meter measuring a torque exerted on the rotor mast 35, a speed sensor measuring, for example, the speed of rotation of this rotor mast 35, a sensor measuring the outside pressure, a sensor measuring the outside temperature, etc.

The engine computers 60 can form a controller 75 applying the method of the disclosure, or a management computer 78 of the regulation system 55 can act as a controller 75. The management computer 78 may comprise at least one processing unit, for example. The management computer 78 can communicate via wired or wireless links with each engine computer 60. The management computer 78 can communicate with each of the above-mentioned measurement systems, either directly or via an engine computer.

Regardless of its composition, the controller 75 can communicate via a wired or wireless link with at least one alerter 80 to provide information to a pilot. For example, the alerter 80 may comprise a display capable of displaying a message, a light-emitting diode that lights up on command from the controller 75, and a loudspeaker.

In addition, the controller 75 can communicate with a human-machine interface 81.

In addition, the controller 75 can communicate with at least one human-machine piloting interface 85, or even with one human-machine piloting interface per engine 10, i.e., two interfaces 86, 87 according to the example given. Each human-machine piloting interface 85 can, for example, emit a signal carrying a stop command, an idle speed command or a flight speed command for the engine 10 concerned. FIG. 1 shows the interfaces in three-positions stop POS1/idle POS2/flight POS 3 used for this purpose.

In addition, the controller 75 can communicate with a human-machine control interface 88 that can be manipulated to activate or deactivate the asymmetric operating mode manually.

Each human-machine interface 81, 85, 88 may comprise a device that can be operated by a pilot, such as a button or a lever for example, a touch screen, a voice command, etc. According to the example shown, the human-machine interfaces 81, 85, 88 and the alerter 80 communicate with the management computer 78. Alternatively or additionally, the human-machine interfaces 81, 85, 88 and the alerter 80 communicate with one or each engine computer unit 60.

Furthermore, the controller 75 can communicate with a plurality of sensors 40-47, 410, 440, 450, 460, 470, directly or via an engine computer. The term “sensor” should be understood to mean a physical sensor capable of directly measuring the parameter in question, but also a system that may comprise one or more physical sensors, as well as means for processing the signal that make it possible to provide an estimation of the parameter based on the measurements provided by these physical sensors. Similarly, the notion of measuring parameters refers to both a raw measurement from a physical sensor and a measurement obtained by relatively complex processing of raw measurement signals.

Thus, the controller 75 can communicate with one or more of the following sensors:
an outside temperature sensor 40 measuring an outside temperature TO of the air surrounding the aircraft 1;
one oil temperature sensor 41, 410 per combustion engine 10, measuring an oil temperature TOIL within a lubrication circuit of the associated combustion engine 10;
at least one fuel temperature sensor 42 measuring a fuel temperature TFUEL of a fuel, the system being able to have a single sensor measuring the temperature of the fuel in the tank 70 or one sensor per engine measuring one fuel temperature per engine;
a speed sensor 43 measuring a current speed of the aircraft 1; such a speed sensor may comprise a satellite positioning system and/or a Pitot tube system, for example;
one ambient temperature sensor 44, 440 per engine 10, measuring an ambient temperature TCOMP in an engine compartment 100;
one internal temperature sensor 45, 450 per combustion engine 10, measuring an internal temperature LTENG in the combustion engine 10, for example the temperature referred to by a person skilled in the art as “T45” upstream of the free turbine of a turboshaft engine;
one oil pressure sensor 46, 460 per combustion engine 10, measuring an oil pressure circulating in the lubrication circuit of a combustion engine 10; and
one fuel pressure sensor 47 per combustion engine 10, measuring a fuel pressure of said fuel circulating in the combustion engine 10.

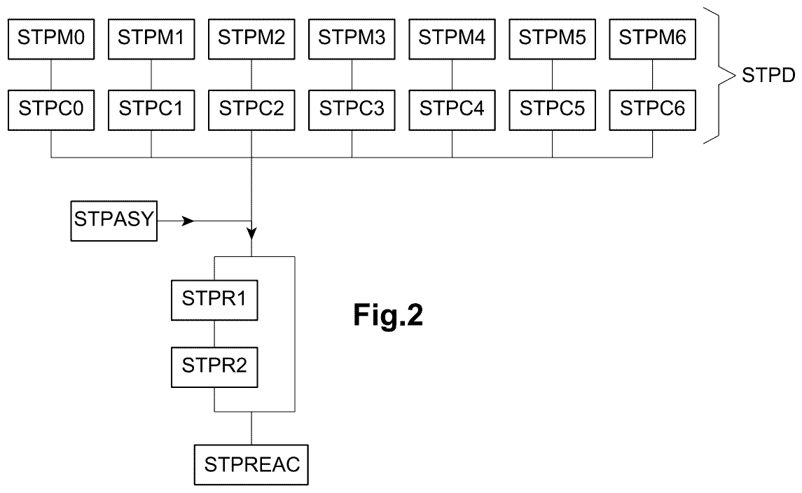

FIG. 2 illustrates the piloting method according to the disclosure, that can be implemented by a rotary-wing aircraft 1 of the type shown in FIG. 1. The method is illustrated using the regulation system 55 of FIG. 1. However, this method is applicable to a regulation system without a management computer 78, as the engine computers 60 can be easily configured to apply it.

During a collaborative operating mode, each combustion engine 10 is a so-called active engine that is regulated by the regulation system 55 to output, via its power shaft 20, a non-zero active driving power that contributes to the rotation of the rotor 5. For example, the first human-machine piloting interface 86 is placed in the position POS3 and transmits a control signal to the engine computer 61. Similarly, the second human-machine piloting interface 87 is placed in position POS3 and transmits a control signal to the engine computer 62.

To activate the asymmetric operating mode, a pilot can maneuver the human-machine control interface 88. The regulation system keeps at least one of the engines, known as the “active engine”, active and puts at least one of the engines, known as the “passive engine”, in standby mode. The one or more passive engines are then either shut down having a shut-down combustion chamber, or idled so as not to transmit power via the associated freewheel.

Optionally, the method may comprise a step of detecting STPASY, using the regulation system 55, that the asymmetrical operating mode is activated, for example by detecting the emission of a signal carrying an order to apply this asymmetric operating mode by the human-machine control interface 88.

When this asymmetric operating mode is activated, the method may include the detection STPD, using the regulation system 55, of an operation of the power plant 2 in an at-risk flight phase preceding a flight phase unfavorable to reactivation of the passive engine.

In some embodiments, said detection STPD, using the regulation system 55, of an operation of the power plant 2 in an at-risk flight phase preceding a flight phase unfavorable to an exit from the asymmetric operating mode is operated independently of the operation of said at least one active engine of the at least two combustion engines 10.

For this purpose, the method may involve measuring STPM0-STPM6 one or more monitoring parameters using one or more of the respective sensors 40-47, 410, 440, 450, 460, 470. The regulation system, and for example the controller 75, therefore detects an operation of the power plant 2 in the at-risk flight phase if at least one of the monitoring parameters has a current value less than its associated limit.

One monitoring parameter may be a function of the outside temperature TO of the air surrounding the aircraft 1 and measured using the outside temperature sensor 40 during a step STPM0. The associated limit is then an outside temperature limit LTO stored in the regulation system 55, or even in the controller 75 for example. The temperature value can then be equal to the outside temperature TO or is calculated by the controller 75 using a stored law based on the outside temperature TO and the current speed of the aircraft 1 measured using the speed sensor 43. The detection STPD of an operation of the power plant 2 in the at-risk flight phase then includes detecting STPC0, using the regulation system 55, or even the controller 75, that the temperature value is less than the stored outside temperature limit LTO.

One monitoring parameter may be an oil temperature TOIL of an oil circulating in the passive engine and measured using an oil temperature sensor 41 during a step STPM1. The associated limit is then an oil temperature limit LTOIL stored in the controller 75. The detection STPD of an operation of the power plant 2 in the at-risk flight phase thus includes the detection STPC1, using the regulation system 55, or even the controller 75, that the oil temperature TOIL has a current value less than the stored oil temperature limit LTOIL.

One monitoring parameter may be a fuel temperature TFUEL of a fuel to be supplied to the passive engine and measured using a fuel temperature sensor 42 in a step STPM2. The associated limit is then a fuel temperature limit LTFUEL stored in the controller 75. The detection STPD of an operation of the power plant 2 in the at-risk flight phase then includes the detection STPC2, using the regulation system 55, or even the controller 75, that the fuel temperature TFUEL has a current value less than the stored fuel temperature limit LTFUEL.

One monitoring parameter may be an ambient temperature TCOMP in the engine compartment 100 housing the passive engine measured using an ambient temperature sensor 44 during a step STPM3. The associated limit is an ambient temperature limit LTCOMP stored in the controller 75. The detection STPD of an operation of the power plant 2 in the at-risk flight phase then comprises the detection STPC3, using the regulation system 55, or even the controller 75, that the ambient temperature TCOMP has a current value less than the stored ambient temperature limit LTCOMP.

One monitoring parameter may be an internal temperature LTENG in the passive engine 10, 11 measured using an internal temperature sensor 45 during a step STPM4. Said associated limit is an internal temperature limit LTENG stored in the controller 75. The detection STPD of an operation of the power plant 2 in the at-risk flight phase then comprises the detection STPC4, using the regulation system 55, or even the controller 75, that the internal temperature LTENG has a current value less than the stored internal temperature limit LTENG.

One monitoring parameter may be an oil pressure POIL of an oil circulating in the passive engine, measured using an oil pressure sensor 46, 460 in a step STPM5. The associated limit is an oil pressure limit LPOIL stored in the controller 75. The detection STPD of an operation of the power plant 2 in the at-risk flight phase then includes the detection STPC5, using the regulation system 55, or even the controller 75, that said oil pressure POIL has a current value less than the stored oil pressure limit LPOIL.

One monitoring parameter may be a fuel pressure PFUEL of a fuel supplying the combustion engines 10 measured using a fuel pressure sensor 47, 470 in a step STPM6. The associated limit is a fuel pressure limit LPFUEL stored in the 75 controller. The detection STPD of an operation of the power plant 2 in the at-risk flight phase then includes the detection STPC6, using the regulation system 55, or even the controller 75, that the fuel pressure PFUEL has a current value less than the stored fuel pressure limit LPFUEL.

Regardless of how it is detected whether the aircraft 1 is in the at-risk flight phase, following detection of an operation of the power plant 2 in the at-risk flight phase, the controller 75 controls an exit from the asymmetric operating mode via reactivation STPREAC of the one or more passive engines.

According to a first variant, the exiting of the asymmetric operating mode comprises transmission STPR1 of an alarm using an alerter 80. The controller 75 transmits an alarm signal to the alerter 80, that emits the alarm. A pilot can, for example, use the human-machine control interface 88. During a step STPR2, the human-machine control interface 88 emits an exit signal received by the controller 75, or no longer emits the signal requiring implementation of the asymmetric mode. This controller 75 consequently controls the reactivation STPREAC in the usual way. For example, the controller 75 transmits a signal to the engine computer, that optionally controls the starter motor and the fuel metering device of the passive engine in the usual way, in order to achieve a collaborative operating mode.

According to a second variant, the reactivation STPREAC of the passive engine 11 is performed automatically by the regulation system 55 following said detection STPD of an operation of the power plant 2 in the at-risk flight phase. For example, the controller 75 transmits an output signal to the engine computer 61 of the passive 11 engine, that can pilot the starter motor and fuel metering valve of the passive engine in the usual way.

Optionally, a pilot can use a human-machine interface 81 to select the variant to be applied during a flight.

In another aspect, before piloting the exit from the asymmetric operating mode, the controller 75 can be configured to detect whether at least one monitoring parameter is greater than or equal to the associated limit and less than or equal to an associated threshold greater than this associated limit. If this is the case, the controller 75 can transmit an alert signal to the alerter 80 to generate an alert signaling entry into a transient phase close to the limit or limits requiring exit from the asymmetrical operating mode.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A method for piloting an aircraft, the aircraft having a power plant comprising at least two combustion engines and a transmission system connected to at least one rotor, each combustion engine having a power shaft connected to the transmission system, the method comprising an asymmetric operating mode comprising regulation at an active speed, using a regulation system, of at least one active engine of the at least two combustion engines, the active engine outputting, at the active speed and via its power shaft, a non-zero active driving power that contributes to the rotation of the rotor, the asymmetric operating mode comprising, together with the regulation of the active engine at the active speed, putting in standby mode at least one passive engine of the at least two combustion engines, the passive engine transmitting no power to the rotor,
wherein during the asymmetric operating mode, the method comprises the following steps:
detecting, using the regulation system, an operation of the power plant in an at-risk flight phase preceding a flight phase unfavorable to an exit from the asymmetric operating mode; and
following the detection of an operation of the power plant in the at-risk flight phase, reactivation, using the regulation system, of the passive engine.

2. The method according to claim 1,
wherein, following detecting an operation of the power plant in the at-risk flight phase, the method comprises emitting an alarm using an alerter, the regulation system reactivating the passive engine following a maneuver by a human-machine control interface.

3. The method according to claim 1,
wherein the reactivation of the passive engine is performed automatically by the regulation system following detecting an operation of the power plant in the at-risk flight phase.

4. The method according to claim 1,
wherein the method comprises a measurement of at least one monitoring parameter using a respective sensor of the regulation system, detecting an operation of the power plant in the at-risk flight phase comprises detecting that the monitoring parameter has a current value less than an associated limit.

5. The method according to claim 4,
wherein the at least one monitoring parameter comprises at least one of the following parameters:
a temperature value function of an outside temperature of the air surrounding the aircraft measured using an outside temperature sensor and the associated limit is a stored outside temperature limit, detecting an operation of the power plant in the at-risk flight phase comprising detecting that the temperature value is less than the stored outside temperature limit;
an oil temperature of an oil of a lubrication circuit of the passive engine measured using an oil temperature sensor and the associated limit is a stored oil temperature limit, detecting an operation of the power plant in the at-risk flight phase comprising detecting that the oil temperature has a current value less than the stored oil temperature limit; and
a fuel temperature of a fuel supplying the passive engine measured using a fuel temperature sensor and the associated limit is a stored fuel temperature limit, detecting an operation of the power plant in the at-risk flight phase comprising detecting that the fuel temperature has a current value less than a stored fuel temperature limit.

6. The method according to claim 5,
wherein the temperature value is equal to the outside temperature or is calculated as a function of the outside temperature and a current speed of the aircraft measured using a speed sensor.

7. The method according to claim 4,
wherein the at least one monitoring parameter comprises an ambient temperature in an engine compartment housing the passive engine, measured using an ambient temperature sensor and the associated limit is a stored ambient temperature limit, detecting an operation of the power plant in the at-risk flight phase comprising detecting that the ambient temperature has a current value less than the stored ambient temperature limit.

8. The method according to claim 4,
wherein the at least one monitoring parameter comprises an internal temperature in the passive engine measured using an internal temperature sensor and the associated limit is a stored internal temperature limit, detecting an operation of the power plant in the at-risk flight phase comprising detecting that the internal temperature has a current value less than the stored internal temperature limit.

9. The method according to claim 4,
wherein the at least one monitoring parameter comprises an oil pressure of an oil of a lubrication circuit of the passive engine, the oil pressure being measured using an oil pressure sensor and the associated limit being a stored oil pressure limit, detecting an operation of the power plant in the at-risk flight phase comprising detecting that the oil pressure has a current value less than the stored oil pressure limit.

10. The method according to claim 4,
wherein the at least one monitoring parameter comprises a fuel pressure of a fuel supplying the passive engine and the associated limit is a stored fuel pressure limit, the fuel pressure being measured using a fuel pressure sensor, detecting an operation of the power plant in the at-risk flight phase comprising detecting that the fuel pressure has a current value less than the stored fuel pressure limit.

11. The method according to claim 4,
wherein the method comprises emitting using the alerter of an alert signaling an operation of the aircraft in a transient phase when the at least one monitoring parameter is greater than or equal to the associated limit and less than or equal to an associated threshold, the associated threshold being greater than the associated limit.

12. The method according to claim 1,
wherein detecting, using the regulation system, an operation of the power plant in an at-risk flight phase preceding a flight phase unfavorable to an exit from the asymmetric operating mode is operated independently of the operation of the at least one active engine of the at least two combustion engines.

13. An aircraft, the aircraft having a power plant comprising at least two combustion engines and a transmission system connected to at least one rotor, each combustion engine having a power shaft connected to the transmission system, the aircraft having an asymmetric operating mode comprising regulation, at an active speed using a regulation system, of at least one active engine of the at least two combustion engines, the active engine outputting, at the active speed and via its power shaft, a non-zero active driving power contributing to the rotating of the rotor, the asymmetric operating mode comprising, together with the regulation of the active engine at the active speed, putting in standby mode at least one passive engine of the at least two combustion engines, the passive engine not transmitting any power to the rotor,
wherein the regulation system is configured to implement the method according to claim 1.

14. The aircraft according to claim 13,
wherein the regulation system comprises at least one of the following sensors: an outside temperature sensor measuring an outside temperature of the air surrounding the aircraft, one oil temperature sensor per combustion engine measuring an oil temperature of an oil, a fuel temperature sensor measuring a fuel temperature of a fuel supplied to each combustion engine, a speed sensor measuring a current speed of the aircraft, one ambient temperature sensor per combustion engine measuring an ambient temperature in an engine compartment housing a combustion engine, one internal temperature sensor per combustion engine measuring an internal temperature in the combustion engine, one oil pressure sensor per combustion engine measuring an oil pressure in the combustion engine, one fuel pressure sensor per combustion engine measuring a fuel pressure of the fuel flowing in the combustion engine.

15. The aircraft according to claim 13,
wherein the regulation system comprises an alerter.
